(19) United States
(12) Patent Application Publication
(10) Pub. No.: US 2007/0076862 A1
(43) Pub. Date: Apr. 5, 2007

(54) System and method for abbreviated text messaging

(76) Inventors: Manjirnath A. Chatterjee, San Francisco, CA (US); Peter Milov, San Jose, CA (US); Eugene A. Mirkin, Cupertino, CA (US); Jason C. Simon, Campbell, CA (US)

Correspondence Address: MOTOROLA INC, 600 NORTH US HIGHWAY 45, ROOM AS437, LIBERTYVILLE, IL, 60048-5343, US

(21) Appl. No.: 11/240,254

(22) Filed: Sep. 30, 2005

(51) Int. Cl. H04M 1/00

(52) U.S. Cl. 379/433.06; 704/9

(57) ABSTRACT

Disclosed is a method and circuit for inputting phrases to a wireless mobile device and retrieving the saved phrases. For retrieval of the phrase, the user will enter a numeric sequence which represents the first letter or symbol of the words of a phrase. The method includes inputting to the wireless communication device a phrase having a plurality of words, each word having a starting letter or symbol. The wireless communication device can process the phrase to correlate one key of the keyboard to the starting letter or symbol of each of the plurality of words of the phrase to generate a numerical sequence representative of the phrase. The user then uses the keypad to input into the wireless communication device the numerical sequence to generate the phrase.

### FIELD OF THE INVENTION

Disclosed is a system and method for text input and more particularly, for text input to a mobile communication device with a reduced number of keypresses.

### BACKGROUND OF THE INVENTION

As more features are added to mobile communication devices, the convenience of the technology has made wireless communication increasingly popular. In addition to voice communication, wireless communication device such as cellular telephones, may receive and transmit text messages that are similar to email. Text messages are input to the device, typically through the keypad of the device, and then transmitted. Users may save valuable cellular minutes by communicating through text messages since they are small files and take little time to transmit over a cellular network.

As wireless mobile device technology has continued to improve, the devices have become increasingly smaller. Therefore, the keypads on the devices have become small, as have the keys. As a result, text input for text messages on cellular telephones for example is constrained by small keypads.

Typically, ten keys of the keypad carry letters and symbols. Accordingly, for most letters, entering text requires that the user enter multiple keypresses per letter. A user must therefore oftentimes press the key carrying the desired letter or symbol many times. For example, the numeric key “9” includes letters, W, X, Y and Z and so inputting “Z” requires four keypresses on the numeric key “9.” While the letters W, X, Y, and Z are not widely used, others that are widely used A, B and C share the numeric key “2.” Each entry of “C” for example requires three keypresses. Inputting a text message into a small keypad with multiple strikes for a single letter or symbol may be difficult for most users.

### BRIEF DESCRIPTION OF THE DRAWINGS

FIG. 1 depicts an exemplary embodiment of a wireless communication device;

FIG. 2 depicts an exemplary embodiment of the method as described herein; and

FIG. 3 illustrates the exemplary retrieval or generation of the phrase, “Talk to you later” by inputting the numerical sequence 8-8-9-5.

### DETAILED DESCRIPTION OF THE INVENTION

Disclosed is a method and circuit for inputting phrases to a wireless mobile device and retrieving the saved phrases. For retrieval of the phrase, the user will enter a numeric sequence which represents the first letter or symbol of the words of a phrase. The method includes inputting to the wireless communication device a phrase having a plurality of words, each word having a starting letter or a symbol. The wireless communication device can process the phrase to correlate one key of the keyboard to the starting letter or the symbol of each of the plurality of words of the phrase to generate a numerical sequence representative of the phrase. The user then uses the keypad to input into the wireless communication device the numerical sequence to generate the phrase.

The instant disclosure is provided to further explain in an enabling fashion the best modes of making and using various exemplary embodiments in accordance with the present invention. The disclosure is further offered to enhance an understanding and appreciation for the invention principles and advantages thereof, rather than to limit in any manner the invention.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts according to the present invention, further discussion of such software and ICs, if any, will be limited to the essentials with respect to the principles and concepts within the preferred embodiments.

Generally, users of text messaging generate short messages. However, even short messages may take a substantial amount of time to enter. By correlating a numerical sequence with the first letter or symbol of each word of a phrase, for retrieval of the phrase from the device, the user can input to the wireless communication device one key per word. A word in this context is any single or group of symbols or characters that may be separated by a space from other words. It is understood that symbols and/or characters includes without limitation letters of the alphabet, numbers, punctuation, pictograms, icons, sounds and the like, and is not limited to the English language or other Western languages, but can also include languages such as Japanese, Chinese or the Cyrillic alphabet. Multiple languages can be utilized including the mixing of multiple types of content.

A phrase is an ordered plurality of words separated by whitespaces. Certain phrases may be repeated by individual users in speech and in writing. For example, in text messaging, users oftentimes repeat phrases such as “how are you?,” “I am home,” and “I'll see you in a bit.” Since the numerical sequence contains the first letters of the words of the phrase, most input sequences are easy for the user to intellectually formulate. In this method, a user need not remember the numeric sequence. The disclosed method and circuit for avoiding re-entering redundant phrases into a wireless communication device and therefore reducing the number of keystrokes per letter and the time required to enter text messages facilitates entry of text messages.

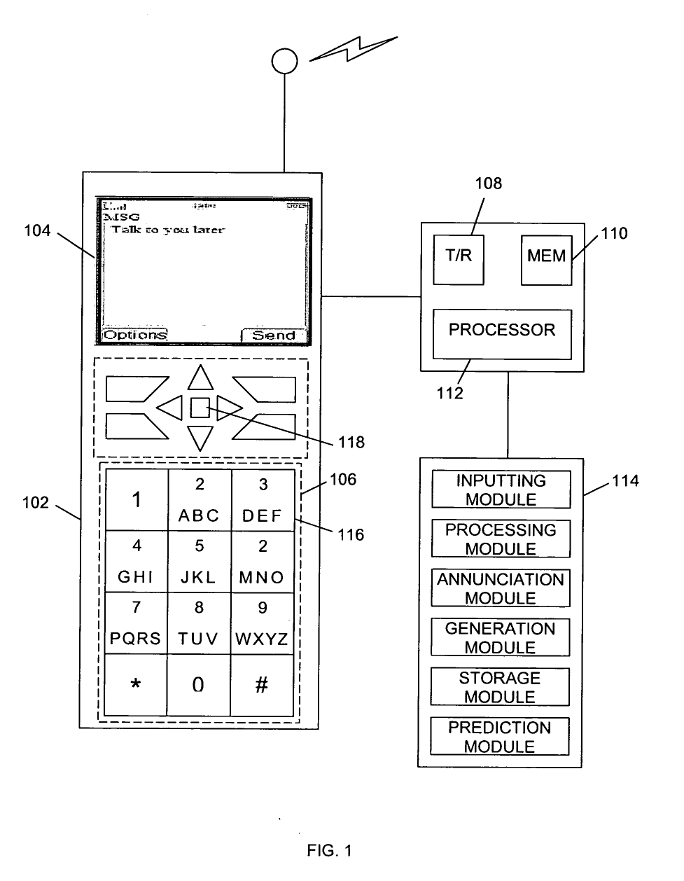

FIG. 1 depicts an exemplary embodiment of a wireless communication device 102, and in particular, a cellular radiotelephone. The wireless communication device 102 represents a wide variety of communication devices that have been developed for use within various networks. Such handheld communication devices include, for example, cellular telephones, messaging devices, mobile telephones, personal digital assistants (PDAs), notebook or laptop computers incorporating communication modems, mobile data terminals, camera phones, video phones, application specific gaming devices, video gaming devices incorporating wireless modems, and the like. Any of these portable devices may be referred to as a mobile station or user equipment.

Text messaging, such as SMS, and other display indicia may be displayed on the display device 104. The electronic device 102 includes input capability such as a key pad 106, a transmitter and receiver 108, a memory 110, a processor 112, and modules 114 that can contain instruction modules that are made up of hardware or software modules or combinations thereof. While these electronic components of the wireless communication device are shown as part of the device, any of their functions in accordance with this disclosure may be wirelessly or via wires, transmitted to and received from electronic components remote to the device 102, also referred to as a distributed system.

Communication networks to transmit and receive text messages include those used to transmit digital data through radio frequency links. The links may be between two or more devices, through radio towers or any other configuration. Examples of communication networks are telephone networks, messaging networks, and Internet networks. Such networks include land lines, radio links, and satellite links, and can be used for such purposes as cellular telephone systems, Internet systems, computer networks, messaging systems and satellite systems, singularly or in combination.

The keypad 106 of the wireless mobile device 102 may further include keypad elements 116. The configuration of the keypad 106 may be in any configuration that is suitable for the use of the wireless communication device. Alternatively, initial entries of the phrases and/or subsequent entries of the numerical sequence can be in audible form if speech recognition is an available option on the device 102.

As shown in FIG. 1, the numerical keypad 106 includes letters, a plurality of which are associated with many numeric keys. As discussed above, most of the time, the user must press a numeric key multiple times to input a letter. For example, the numeric key “9” includes letters, W, X, Y and Z. Accordingly, inputting the letter “Z” requires four presses on the “9” key in order to cycle through the letters to arrive at the letter “z.”.

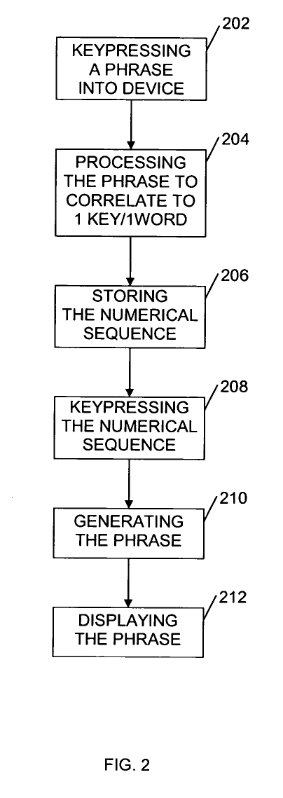

In one embodiment of the disclosed method, as illustrated in FIG. 2, a user can keypress into the keypad of the wireless communication device 102, a phrase 202 which may be displayed on the display device 104. A phrase, “Talk to you later” that may be input the device 102 is shown on the display screen 104. As mentioned above, a phrase can have a plurality of words, each word having a starting letter or a symbol. The process of text entry includes keypress disambiguation (for example, a scrollable selection list, cycle through or the like), word completion, nextword prediction and phrase abbreviations. Disambiguation in general is the process of mapping more than character to a keypress. Since the last three of the foregoing list are not intrusive, a special keypress may be made. Each of the lists may have at least two annunciation configurations including being displayed on its own, or shown as a pop-up.

Disambiguation is a process in which a keypress triggers activation of letters bound to the key. For example, pressing key 2 will disambiguate it to “a”, “b”, “c”, “2”. Preferably, letters are ordered alphabetically and also are cycled through. In another embodiment, letters may be presented statistically, that is, in order of frequency of occurrence, rather than alphabetically. In still another embodiment, letters may be presented all at once instead of being cycled through. It will be appreciated that multiple keypresses may be disambiguated separately or together. The latter is the fundamental principle of predictive text entry—the system tries to match keypresses with dictionary words.

The phrase is processed by the processor 112 of the device, to correlate one key of the keyboard to the starting letter or the symbol of each of the words of the phrase to generate a numerical sequence representative of the phrase 204. The processing will be discussed in more detail below. The numerical sequence may be stored 206 in the memory 110 of the device. The user may then keypress a numerical sequence 208 to retrieve or generate a phrase 210. The phrase may then be annunciated 212 on the display 104, audibly or in any other manner.

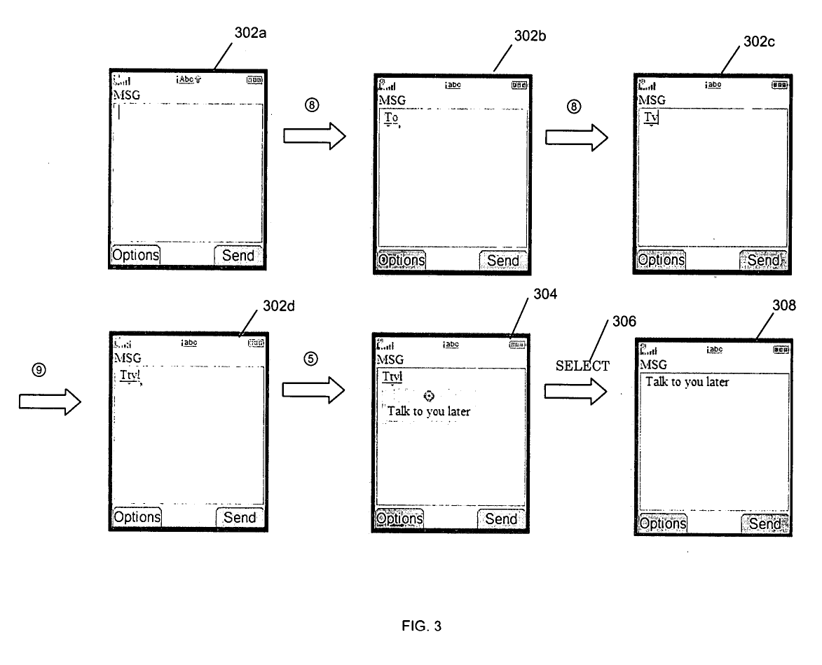

FIG. 3 illustrates the retrieval or generation of the phrase, “Talk to you later” on the display screen 302a-d. This is achieved by inputting the numerical sequence 8-8-9-5 by pressing the “8” key for the letter “t, then pressing the “8” key a second time for the letter “t38 for the word “to,” then pressing the “9” key for the letter “y” for the word “you,” and finally pressing the “5” key for the letter “1” for the word “later.” The user can have a phrase dictionary stored in the wireless communication device memory 110. After the numerical sequence is entered, a phrase can be displayed as shown in screen 304. If more matches are found, they can be displayed also. The user can actively “select” 306 (by keypad button 118 for example) to choose the appropriate phrase 308.

There can be several static dictionaries and several dynamic (personal) dictionaries. Dictionaries are supplied in an ordered list, so the first dictionary gets the highest priority, second gets second to highest, and so on. Dictionary rank is the position of the dictionary amongst other dictionaries that was the source of the prediction.

A user can begin phrase entry with a static dictionary which subsequently changes dynamically as the user enters text. There are different manners in which to enter text such as implicit registration which can be an ordinary entry or explicit registration which can include a menu for creation of shortcuts. The dictionary can be stored in a dynamic database. The dictionary may store the short hand automatically upon entry of the phrase (i.e. store the numbers associated with the first letters of each word).

The phrases in the dictionary are ranked for predictability. A phrase which is more predictable, because its frequency is higher and/or its last use is more recent, will occur earlier in the dictionary than a less predictable phrase. Since more than one phrase can have the same numeric sequence, the processing steps 204 and 210 include the use of predictive algorithms.

Depending on the context, one may want to have words and phrases from the personal dictionary have a higher priority; or, the static dictionary corresponding to the primary language may have a higher priority than the one corresponding to the secondary language. As will be discussed in more detail below, entries in the dynamic database may be ordered according to frequency and/or recency.

Were a user to have previously stored the phrase, or if the phrase were part of a previously installed dictionary, the user may input the numerical sequence 8-8-9-5 to retrieve the phrase “Talk to you later.” The number key “8” corresponds to the first letters of the word “Talk” and “to,” the number key “9” to the first letter of the word “you,” and the number key “5” corresponds to the first letter of the word “later.” With four keystrokes, the entire phrase, “Talk to you later” is retrieved.

The number keys also correspond to symbols that may not be shown on the key. For example, the number key “1” may correspond to a symbol such as a question mark, an exclamation point, or a happy face which may be added to the end of a sentence. A user may enter punctuation explicitly to the phrase prior to storage. Many more keypresses of a number key would otherwise be required to reach a symbol. In some wireless communication devices, a screen may be activated to display all available symbols, and from those, a symbol can be added to the sentence. Punctuation may also be added after entering the numeric sequence and retrieving the phrase.

In the processing step 204 of FIG. 2, each keypress is such that one of its associated letters matches the first character of subsequent a word. For example, in order to enter the sentence or phrase “How are you?” in four keypress, the user can enter 4-2-9-1 (the spaces can be skipped). Accordingly, the process allows the user to quickly recover any currently available sentence or phrase without entering each letter. In other words, the number of keypresses entered by the user to retrieve a sentence can match the number of words in the sentence or phrase.

Which phrase fragments match keypresses may be determined as the keypresses are entered. As each keypress is disambiguated, each of the resulting letters is matched with the initial character of the corresponding word. If, after all keypresses are processed, several phrases match, then all are returned, sorted in order of usage.

Once the user has entered one or more phrases, a dictionary within the device is formed. In the event that two or more phrases are stored in memory with the same numerical sequences, the above-described method and circuit can be merged with a predictive input method. A list of two or more phrases entered with the same numerical sequences can therefore be good candidates for the retrieved sentence or phrase. Predictive input methods can operate so that each new keypress leads to re-evaluation of prediction. It is understood that other predictive input methods than those described herein may be used as well.

One exemplary embodiment includes a method for predicting which of the different phrases to generate based on an order of usage probability which can include determining the generation frequency of the phrase and determining the generation recency of the phrase. Frequency is the number of times the sentence was saved (i.e. previously used). Recency is the age rank of the sentence relative to other sentences. The most recent sentence has the highest recency (equal to the number of sentences minus 1), the oldest has 0. Alternates (to the most frequent/most recent) are graded.

In another exemplary embodiment, a predictive method includes generating phrases according to the keypresses prior to and/or after the numerical sequence. Predictive algorithms may be used singularly or combined to customize retrieval of phrases according to user preferences or provided in installed software.

There are several manners in which the user can be notified as to which phrases are available. For instance, the editor can offer phrases as a separate mode upon pressing a key such as “#” predictions to toggle from letter combinations to phrases and back again. Therefore, the user can toggle back and forth between the text messaging application and a full word entry.

Sorting and listing phrases can be further customized to provide phrase abbreviations for phrases saved in a special way. There can be options for registering abbreviations: implicitly, explicitly or both. Sorting and listing phrases can include reference to common shortcuts, for example, bb=bye-bye, and cya=see you later, and others that are, for example, commonly used in chat room communication. Shortcuts can also be applied to phone messaging. Complete sentences can be formed from their initials. Additionally, phrases may be merged with irregular combinations. Accordingly, sentences can be formed by combining a plurality of numerical sequences to generate a plurality of related phrases.

The use of predictive methods merged with the processing of a numerical sequence to retrieve a phrase can also benefit from considering the environment, which includes the count of context parameters of the stored and current form that match, as explained here. The predictive methods described herein generally operate in accordance with what are referred to as forms. In general, a form is a collection of named and typed fields. The form may be the context preceding and the context trailing the text or the surrounding field for example. A form carries a name and a name of the application to which the form belongs. When a message is sent (or a phonebook entry is added), the entire form is saved to a user dictionary. Over time, the dictionary accumulates content taken from various applications and forms into which the user previously entered text. Next, when the user enters new text, the new form is matched against each stored form to determine which stored form can offer the best contextual match. Parameters counted in environment match, i.e. the count of parameters in this form that match, may include the application name, the form name, field names (if the current form has the same structure as the stored form), and field types (with a similar precondition).

By correlating a numerical sequence with the first letter or symbol of each word of a phrase, for retrieval of the phrase from the device, the user can input to the wireless communication device one key per word. In this manner, time savings can be available to the user since entry of text messages into a wireless communication device can take place with a reduced number of keystrokes.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitable entitled.

1. A method for text input to a wireless communication device, the method comprising:
processing a numerical sequence to retrieve a phrase from a memory, the phrase having a plurality of words, each of the words having a starting letter or symbol, each correlated with a numerical key of the keyboard, the numerical sequence formed from a plurality of single numerical keypresses, each keypress correlated to a starting letter or symbol of a word of the phrase; and
generating the phrase.

2. The method as recited in claim 1 further comprising:
annunciating the phrase.

3. A method as recited in claim 1 wherein a plurality of the same numerical sequences represents different phrases, the method further comprising:
predicting which of the different phrases to generate in generating the phrase based on an order of useage probability.

4. A method as recited in claim 3 wherein the order of usage probability comprises:
determining the generation frequency of the phrase; and
determining the generation recency of the phrase.

5. A method as recited in claim 3 wherein a plurality of the same numerical sequences represents different phrases, the method further comprising
predicting which of the different phrases to generate in generating the phrase according to the keypresses prior to the numerical sequence processing.

6. A method as recited in claim 1 further comprising:
combining a plurality of numerical sequences to generate a plurality of phrases.

7. A method as recited in claim 1 wherein a plurality of the same numerical sequences represents different phrases, the method further comprising:
annunciating the different phrases on a display screen of the wireless communication device.

8. A method for inputting text to a wireless communication device, the method comprising:
keypressing into a keyboard of the wireless communication device, a phrase having a plurality of words, each word having a starting letter or symbol;
processing the phrase to correlate one key of the keyboard to the starting letter or symbol of each of the plurality of words of the phrase to generate a numerical sequence representative of the phrase; and
keypressing into the keyboard the numerical sequence to generate the phrase.

9. A method as recited in claim 8 further comprising:
annunciating the phrase on a display screen of the wireless communication device.

10. A method as recited in claim 8 further comprising;
keypressing into the keyboard a plurality of phrases each having a plurality of words, each word having a starting letter or symbol;
processing the phrases to correlate one key of the keyboard to the starting letter or symbol of each of the plurality of words of the plurality of phrases;
forming a dictionary; and
keypressing into the keyboard at least one numerical sequence to generate a phrase retrieved from the dictionary.

11. A method as recited in claim 8 further comprising:
predicting the phrase to generate based on keypressing a numerical sequence when there are at least two of the same numerical sequences representing different phrases in the dictionary.

12. A method as recited in claim 8 further comprising:
combining a plurality of numerical sequences to generate a plurality of phrases.

13. A method as recited in claim 12 further comprising:
inserting text between the plurality of phrases.

14. A method as recited in claim 12 further comprising:
inserting punctuation between the plurality of phrases.

15. A circuit comprising:
an inputting module for inputting a numerical sequence;
a processing module for processing the numerical sequence to retrieve a phrase from a memory, the phrase having a plurality of words, each of the words having a starting letter or symbol, each of which is correlated with one numerical key of a keyboard,; and
a generation module for generating the phrase.

16. The circuit as recited in claim 15 further comprising:
an annunciation module for annunciating the phrase on a display screen of the wireless communication device.

17. A circuit as recited in claim 15 further comprising:
a storage module for storing in the memory a plurality of phrases to form a dictionary.

18. A circuit as recited in claim 15 further comprising:
a prediction module for predicting the phrase to generate based on keypressing a numerical sequence when there are at least two of the same numerical sequences representing different phrases in the dictionary.

19. A circuit as recited in claim 15 wherein the circuit is a component of a mobile communication device.

20. A circuit as recited in claim 15, wherein the inputting module is coupled to a keyboard and
wherein the generating module is coupled to a display screen.
